(19) United States
(12) Patent Application Publication
(10) Pub. No.: US 2005/0238422 A1
(43) Pub. Date: Oct. 27, 2005

(54) Snap connecting device

(76) Inventor: Hsi-Lu Hung, Changhua Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/833,686

(22) Filed: Apr. 27, 2004

(51) Int. Cl. F16M 11/00

(52) U.S. Cl. 403/379.4

(57) ABSTRACT

A snap connecting device is used to connect an inner tube and an outer tube. The snap connecting device includes an elastic member, and a snapping member mounted on a distal end of the elastic member to lock the outer tube on the inner tube. The snapping member has a side formed with an oblique face. Thus, when the snapping member is pressed inward, the user's one finer only touches the oblique face of the snapping member, so that the user's one finer escapes from the gap defined between the locking hole of the outer tube and the snapping member, thereby preventing the user's one finer from being injured so as to ensure safety of operation of the snap connecting device.

### BACKGROUND OF THE INVENTION

1. Field of the Invention

The present invention relates to a snap connecting device, and more particularly to a snap connecting device for connecting two tubes.

2. Description of the Related Art

A conventional snap connecting device 3 in accordance with the prior art shown in FIG. 4 is used to connect an inner tube 2 and an outer tube 1. The inner tube 2 is formed with a through hole 21 and the outer tube 1 is formed with a locking hole 11. The snap connecting device 3 comprises an elastic member 31 mounted in the inner tube 2, and a snapping member 32 mounted on a distal end of the elastic member 31, extended through the through hole 21 of the inner tube 2 and protruded outward from the locking hole 11 of the outer tube 1, so that the outer tube 1 is locked on the inner tube 1.

As shown in FIG. 5, the conventional snap connecting device 3 is available for an umbrella 70.

As shown in FIG. 6, the conventional snap connecting device 3 is available for a table 72.

As shown in FIG. 7, the conventional snap connecting device 3 is available for a rack 74.

In operation, the user applies a force on the snapping member 32 to detach the snapping member 32 from the locking hole 11 of the outer tube 1, so that the outer tube 1 is detached from the inner tube 2.

However, when the user applies a force on the snapping member 32 to press the snapping member 32 inward, the user's one finer is in point contact with the snapping member 32. Thus, the user's one finer is easily clipped and injured by the gap “A” defined between the locking hole 11 of the outer tube 1 and the snapping member 32.

### SUMMARY OF THE INVENTION

In accordance with the present invention, there is provided a snap connecting device, comprising:
an inner tube formed with a through hole;
an outer tube mounted on the inner tube and formed with a locking hole; and
a snapping member extended through the through hole of the inner tube and protruded outward from the locking hole of the outer tube, so that the outer tube is locked on the inner tube;
the snapping member having a side formed with an oblique face.

The primary objective of the present invention is to provide a snap connecting device for connecting two tubes, wherein a user can operate the snap connecting device easily and safely.

Another objective of the present invention is to provide a snap connecting device, wherein when the snapping member is pressed inward, the user's one finer only touches the press portion of the oblique face of the snapping member, so that the user's one finer escapes from the gap defined between the locking hole of the outer tube and the snapping member, thereby preventing the user's one finer from being injured or hurt so as to ensure safety of operation of the snap connecting device.

Further benefits and advantages of the present invention will become apparent after a careful reading of the detailed description with appropriate reference to the accompanying drawings.

### BRIEF DESCRIPTION OF THE DRAWINGS

FIG. 1 is a partially cut-away exploded perspective view of a snap connecting device in accordance with the preferred embodiment of the present invention;

FIG. 2 is a plan cross-sectional assembly view of the snap connecting device as shown in FIG. 1;

FIG. 3 is a schematic operational view of the snap connecting device as shown in FIG. 2;

FIG. 4 is a partially cut-away plan cross-sectional operational view of a conventional snap connecting device in accordance with the prior art;

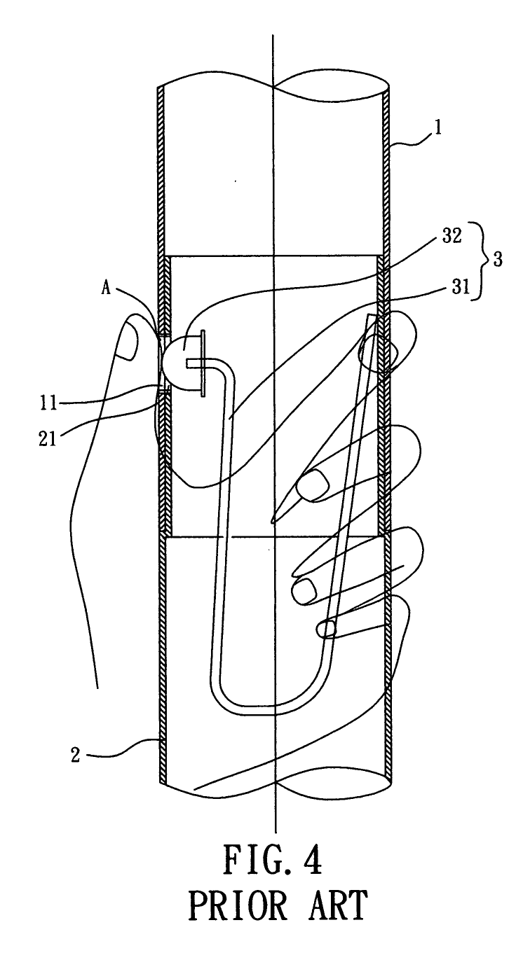

FIG. 5 is a perspective view showing usage of the conventional snap connecting device as shown in FIG. 4;

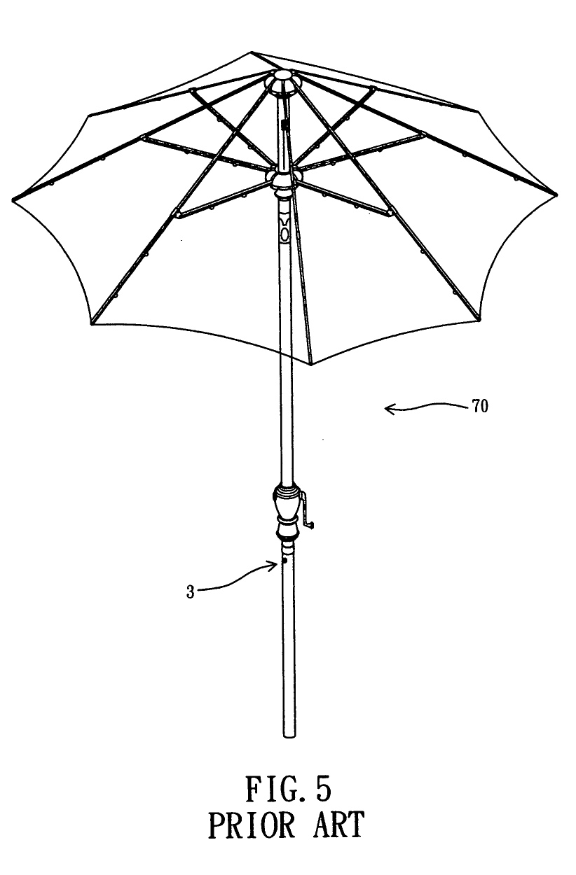

FIG. 6 is a perspective view showing usage of the conventional snap connecting device as shown in FIG. 4; and

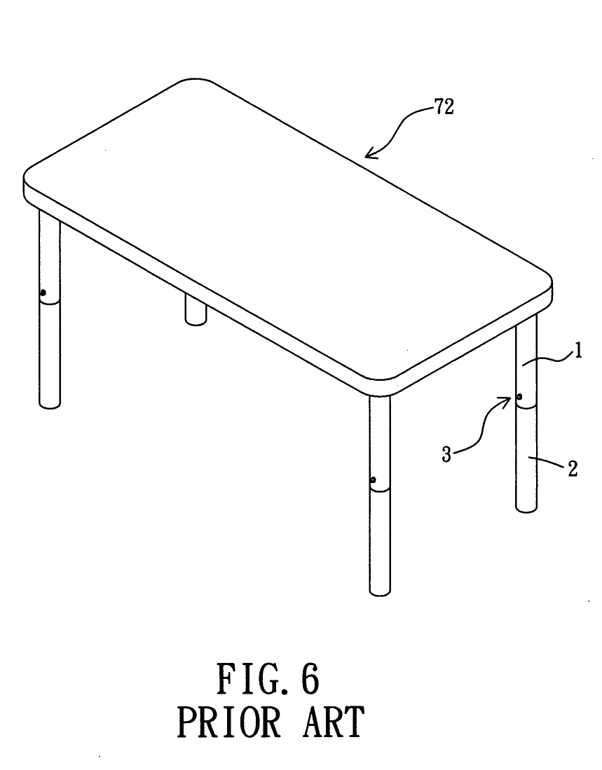

FIG. 7 is a perspective view showing usage of the conventional snap connecting device as shown in FIG. 4.

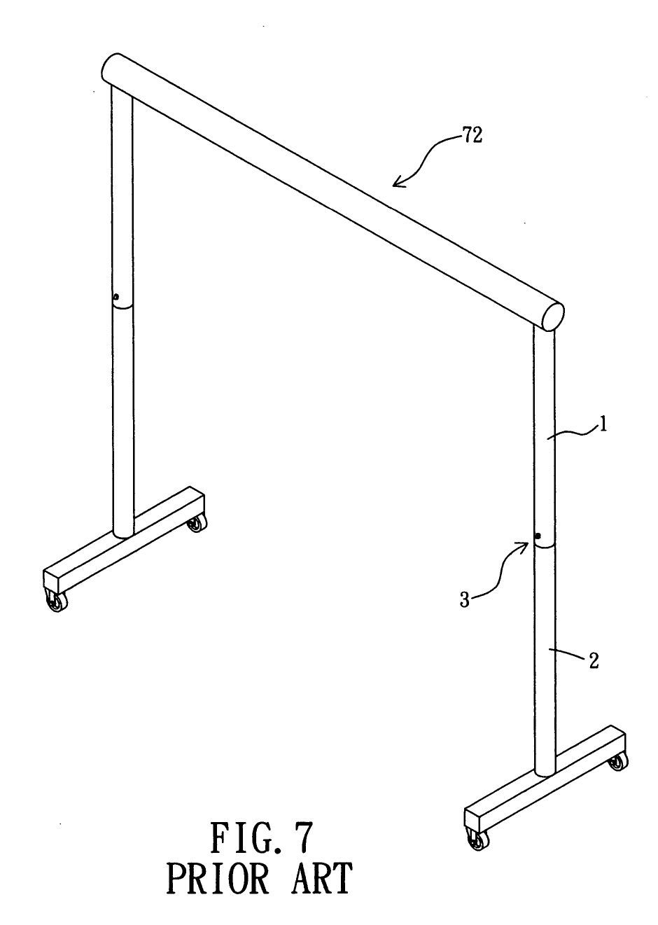

### DETAILED DESCRIPTION OF THE INVENTION

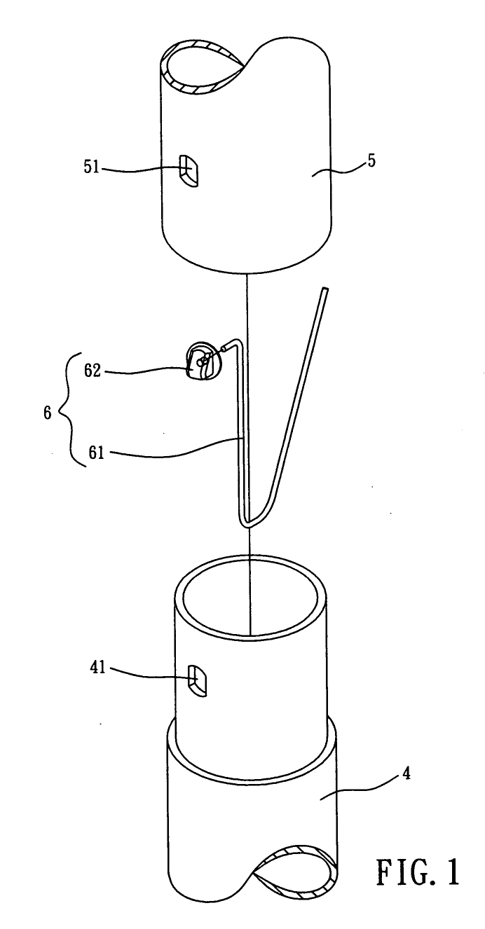

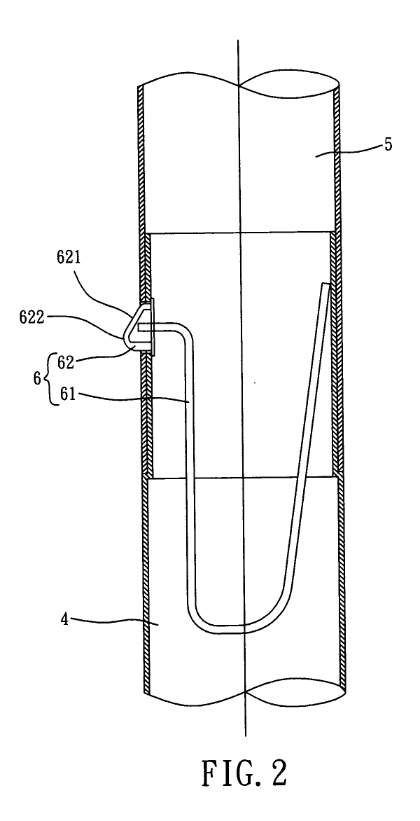

Referring to the drawings and initially to FIGS. 1 and 2, a snap connecting device 6 in accordance with the preferred embodiment of the present invention is used to connect an inner tube 4 and an outer tube 5.

The inner tube 4 is formed with a through hole 41 and the outer tube 5 is formed with a locking hole 51. The snap connecting device 6 comprises an elastic member 61 mounted in the inner tube 4, and a snapping member 62 mounted on a distal end of the elastic member 61, extended through the through hole 41 of the inner tube 4 and protruded outward from the locking hole 51 of the outer tube 5, so that the outer tube 5 is locked on the inner tube 4. The snapping member 62 has a side formed with an oblique face 621 which has a smooth surface. Preferably, the oblique face 621 of the snapping member 62 has an end formed with an arcuate press portion 622 to facilitate a user pressing the oblique face 621 of the snapping member 62.

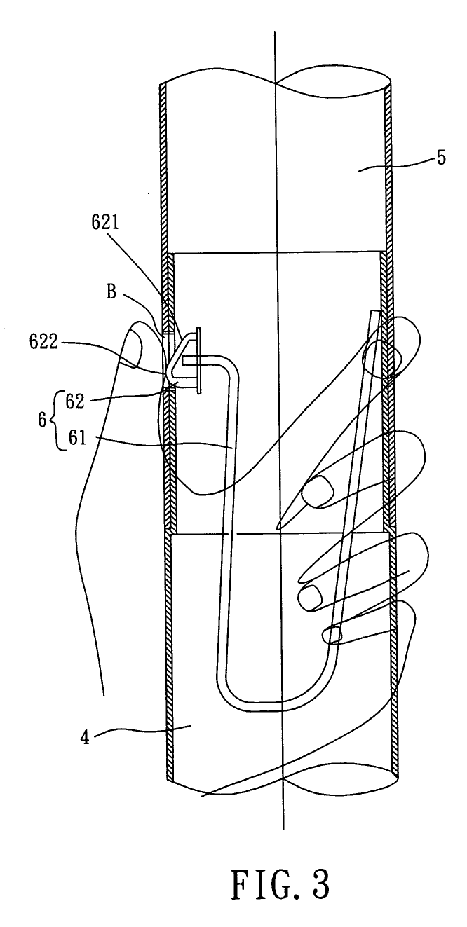

As shown in FIG. 3, the user applies a force on the snapping member 62 to detach the snapping member 62 from the locking hole 51 of the outer tube 5, so that the outer tube 5 is detached from the inner tube 4.

In such a manner, when the user applies a force on the snapping member 62 to press the snapping member 62 inward from the locking hole 51 of the outer tube 5, the user's one finer is in plane contact with the oblique face 621 of the snapping member 62. Thus, the user's one finer only touches the press portion 622 at one end of the oblique face 621 of the snapping member 62, so that the user's one finer escapes from the gap “B” defined between the locking hole 51 of the outer tube 5 and the snapping member 62, thereby preventing the user's one finer from being clipped or hurt by the gap “B” so as to ensure safety of operation of the snap connecting device 6.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A snap connecting device, comprising:
an inner tube formed with a through hole;
an outer tube mounted on the inner tube and formed with a locking hole; and
a snapping member extended through the through hole of the inner tube and protruded outward from the locking hole of the outer tube, so that the outer tube is locked on the inner tube;
the snapping member having a side formed with an oblique face.

2. The snap connecting device in accordance with claim 1, wherein the oblique face of the snapping member has a smooth surface.

3. The snap connecting device in accordance with claim 1, wherein the oblique face of the snapping member has an end formed with an arcuate press portion.

4. The snap connecting device in accordance with claim 1, further comprising an elastic member mounted in the inner tube, wherein the snapping member is mounted on a distal end of the elastic member.
